(19) United States
(12) Patent Application Publication
(10) Pub. No.: US 2025/0301533 A1
(43) Pub. Date: Sep. 25, 2025

(54) COMMUNICATION DEVICE AND METHOD OF OPERATING SUCH A COMMUNICATION DEVICE

(71) Applicant: Telefonaktiebolaget LM Ericsson (publ), Stockholm (SE)

(72) Inventors: Dung PHAM VAN, Upplands Väsby (SE); Muhammad Ali KAZMI, Sundbyberg (SE); Erik STARE, Sollentuna (SE)

(21) Appl. No.: 18/863,051

(22) PCT Filed: May 9, 2023
(86) PCT No.: PCT/EP2023/062255

§ 371 Date: Nov. 5, 2024

Related U.S. Application Data
(60) Provisional application No. 63/339,666, filed on May 9, 2022.

(51) Int. Cl. H04W 76/40; H04W 4/06

(52) U.S. Cl. CPC H04W 76/40; H04W 4/06

(57) ABSTRACT

Embodiments herein may relate to a method of operating a communication device of a communications network. The communication device receives a portion of multicast data of a MBS session via a first cell of the communications network while the communication device is in a low power state. The communication device determines that a first trigger for performing a cell change has occurred, and determines that a criterion associated with a second cell is better than a criterion associated with the first cell. The communication device attempts, or does not attempt, the cell change from the first cell to the second cell, taking into account whether MBS is supported by the second cell and/or whether an MBS session is already provided in the second cell.

### INTRODUCTION

The present disclosure is related to a communication device and a method of operating such a communication device in a communications network and more particularly to reception of new radio multicast services by inactive communication devices.

### BACKGROUND

FIG. 1 illustrates an example of a new radio (NR) network, e.g., a 5th

Generation (5G) network, including a 5G core (5GC) network, network nodes, e.g., 5G base station “gNBs”, multiple communication devices, also referred to as user equipment (UE).

Mobility in low activity radio resource control (RRC) state is described below. In low activity RRC state, e.g., RRC idle/inactive states, a UE performs measurements (e.g., reference signal received power (RSRP), reference signal received quality (RSRQ), on its serving cell once every one or more discontinuous reception (DRX) cycles and may further perform measurements on one or more neighbour cells when the quality of serving cell measurements fall below a threshold value or if the UE cannot fulfill cell selection criteria (S) for the serving cell. The UE performs cell selection or cell reselection to another cell, e.g., a neighbour cell, if it meets cell selection or cell reselection criteria respectively.

In some examples, the cell selection criterion (S) for a cell is fulfilled when the UE determines that the following condition is met by the UE:

Sᵣₓₗₑᵥ>0 AND S_{qual}>0,

In additional or alternative examples, Sᵣₓₗₑᵥ is further defined as follows:

Sᵣₓₗₑᵥ=Qᵣₓₗₑᵥₘₑₐₛ−(Qᵣₓₗₑᵥₘᵢₙ+Q_{rxlevminoffset})−P_{compensation}−Q_{offsettemp}

Sᵣₓₗₑᵥ is the cell selection received (RX) level value in dB, e.g., derived from reference signal received power (RSRP). S_{qual} is the cell selection quality value in dB, e.g., derived from reference signal received quality (RSRQ). Qᵣₓₗₑᵥₘₑₐₛ is the measured cell RX level value, such as RSRP. Qᵣₓₗₑᵥₘᵢₙ is the minimum required RX level in the cell in dBm, in some examples, it is signaled by the cell. Q_{rxlevminoffset} is the offset to the signaled Qᵣₓₗₑᵥₘᵢₙ, in some examples, it is signaled by the cell. Q_{offsettemp} is the offset temporarily applied to a cell, in some examples, it is signaled to the UE by the cell.

The UE may also perform one or more cell selection procedures for the selected public land mobile network (PLMN) if the UE cannot find suitable cell after searches and measurements. An example of cell selection procedures for the selected PLMN include the UE scanning all radio frequency (RF) channels in the NR bands according to its capabilities to find or detect a suitable cell.

The UE can use stored information of frequencies and optionally also information on cell parameters from previously received measurement control information elements or from previously detected cells for selecting a cell.

The UE can filter each of the serving cell measurements, e.g., synchronization signal (SS)-RSRP and SS-RSRQ measurements of the serving cell, using at least two measurements. Within the set of measurements used for the filtering, at least two measurements shall be spaced by, at least discontinuous reception (DRX) cycle/2. If the UE has evaluated according to the table in FIG. 2a, that in Nₛₑᵣᵥ consecutive DRX cycles the serving cell does not fulfill the cell selection criterion (S) defined in TS 38.304 v16.7.0, then the UE shall initiate the measurements of all neighbour cells indicated by the serving cell, regardless of the measurement rules currently limiting UE measurement activities.

Another example of requirements for different NR intra-frequency measurements, e.g., NR cell identification, SS-RSRP, and SS-RSRQ, performed by the UE in RRC_IDLE and RRC_INACTIVE is shown in the table in FIG. 2b. The UE identifies new intra-frequency cells and performs SS-RSRP and SS-RSRQ measurements of the identified intra-frequency cells within T_{detect,NR_intra}. The UE measures SS-RSRP and SS-RSRQ of the identified intra-frequency cells at least every T_{measure,NR_Intra}. The UE evaluates an identified cell for cell reselection within T_{evaluate,NR_Intra}. SS-RSRP and SS-RSRQ of the identified intra-frequency cells at least every T_{measure,NR_Intra}. The UE filters SS-RSRP and SS-RSRQ measurements of each measured intra-frequency cell using at least two measurements. Within the set of measurements used for the filtering, at least two measurements shall be spaced by at least T_{measure,NR_Intra}/2.

Similar requirements are specified for NR inter-frequency measurements, e.g., cell identification, SS-RSRP, and SS-RSRQ, and inter-RAT measurements, e.g., long term evolution (LTE) cell identification, LTE RSRP, and LTE RSRQ, performed by the UE in RRC_IDLE and RRC_INACTIVE.

### SUMMARY

There currently exist one or more certain challenges. When the communication device is in RRC_INACTIVE or RRC_IDLE state, it performs cell reselection, e.g., choosing the best cell to camp on, based on cell reselection criteria which involve measurements of the serving and neighbour cells, as described in TS38.300, 9.2. Legacy mobility in RRC_INACTIVE ensures that the communication device reselects the strongest/highest ranked cell on a frequency and tries to reselect to a higher priority frequency based on its measurements of the serving and neighbour cells. With newly introduced multicast reception for RRC_INACTIVE in release (Rel)-18, existing cell reselection procedure may impact on the continuity of multicast data reception by a RRC_INACTIVE UE. For example, the communication device may reselect a cell to camp on that is the best cell based on current reselection criteria, but the cell may not provide the multicast session. Whereas reselection to another good cell, e.g., the second best one according to the existing criteria, that is currently providing the multicast session would be more beneficial. Therefore, it can be expected that cell re-selection criteria may be updated taking into account multicast data reception aspect, while not negatively affecting legacy communication device behaviour. In addition, when the RRC_INACTIVE communication device reselects a cell and performs mobility, the communication device may need to access the new cell in order to ensure it has right configuration information for multicast data reception. It is desirable to enable the communication device to quickly obtain multicast and broadcast services (MBS) configuration information and continue receiving the same multicast session.

In legacy, an RRC_INACTIVE communication device does not need to access a new cell/gNB if it moves within the radio access network (RAN) notification area (RNA), except for the cases where the UE, at the new cell/gNB, has data or signalling to transmit or receive or its periodic RNA update timer expires or it is RAN paged for downlink (DL) data/signalling. The network configures value for periodic RNA update when releasing the communication device to RRC_INACTIVE, e.g., via PeriodicRNAU-TimerValue in the RRCRelease message. In such cases, accessing a new cell/gNB, the RRC_INACTIVE communication device performs resume procedure that requires the last serving cell and the new cell to exchange the communication device Inactive access stratum (AS) context, e.g., UE context, via the Xn Context retrieval procedure.

An object of embodiments herein is to overcome one or more of the issues discussed above.

According to embodiments herein the object is achieved by providing a method of operating a communication device of a communications network. The communication device receives a portion of multicast data of an MBS session via a first cell of the communications network while the communication device is in a low power state. The communication device determines that a first trigger for performing a cell change has occurred; and determines that a criterion associated with a second cell is better than a criterion associated with the first cell. The communication device attempts, or not attempts, the cell change from the first cell to the second cell, taking into account whether MBS is supported by the second cell and/or whether an MBS session is already provided in the second cell.

According to embodiments herein the object is achieved by providing a communication device operating in a communications network. The communication device comprises processing circuitry; and memory coupled to the processing circuitry and having instructions stored therein that are executable by the processing circuitry to cause the communication device to perform operations comprising any of the operations of embodiments herein.

Certain aspects of the disclosure and their embodiments may provide solutions to one or more of the above or other challenges. Various embodiments herein enable RRC_INACTIVE UEs to continue reception of MBS service(s) with reduced/minimal data loss when/while moving to a new RAN node with minimal service interruption taken into consideration.

In some embodiments, RRC_INACTIVE UEs are allowed to continue receiving multicast MBS services at the current serving cell, e.g., cell1, as long as possible or at a new cell with minimal interruption/setup time. In some examples, the communication device, while receiving multicast MBS services from the current serving cell. is triggered to perform a cell change, e.g., cell selection, cell reselection, to a target cell, e.g., cell2.

In some embodiments, the communication device delays or postpones the cell reselection to another cell, e.g., cell2, when the reception quality of the current serving cell, e.g., cell1, is still acceptable, e.g., signal level such as RSRP and/or RSRQ are above respective thresholds. In some examples, the network defines and provides communication devices with a new threshold for quality of reception of multicast data below which it is considered unacceptable. In additional or alternative examples, the communication device measures reception quality and continues multicast reception in cell1 if the reception quality of cell1 is within acceptable range.

In additional or alternative embodiments, the communication device reselects to another cell, e.g., cell3, which has an ongoing MBS session(s), and whose level, e.g., RSRP, RSRQ, signal to interference and noise ratio (SINR), is acceptable, e.g., signal level such as RSRP and/or RSRQ are above respective thresholds, although it may not be the strongest candidate cell.

In additional or alternative embodiments, the communication device accesses the strongest cell, e.g., cell2, and requests setup of a MBS session to continue MBS data reception therein from cell2. The communication device may send the MBS session establishment request to cell1 or to the target cell (cell2), e.g., after the cell change. In some examples, this is triggered if the reception quality of cell1 is not acceptable and there is not an acceptable cell2 to change to offering MBS.

In additional or alternative examples, the communication device while receiving MBS data from the serving cell (cell1) does not meet cell selection criterion in cell1 or is unable to successfully perform the cell change to a target cell, e.g., cell2 is barred, then the communication device determines based on one or more rules whether to stop or suspend or continue the reception of the ongoing MBS session in cell1.

Certain embodiments may provide one or more of the following technical advantages. In some embodiments, RRC_INACTIVE UEs are allowed to continue receiving multicast MBS services at the current serving cell as long as possible or at a new cell with minimal interruption/setup time.

### BRIEF DESCRIPTION OF THE DRAWINGS

The accompanying drawings, which are included to provide a further understanding of the disclosure and are incorporated in and constitute a part of this application, illustrate certain non-limiting embodiments. In the drawings:

FIG. 1 is a schematic diagram illustrating an example of a 5G network;

FIG. 2a is a table illustrating an example of an evaluation of a serving cell during Nₛₑᵣᵥ;

FIG. 2b is a table illustrating an example of intra-frequency cell reselection requirements in NR;

FIG. 3a is a schematic diagram illustrating an example of a network according to embodiments herein;

FIG. 3b is a schematic flowchart illustrating a method flow according to embodiments herein;

FIG. 4 is a flow chart illustrating an example of operations performed by a communication device in accordance with some embodiments;

FIG. 5 is a flow chart illustrating an example of operations performed by a communication device in accordance with some embodiments;

FIG. 6 is a flow chart illustrating an example of operations performed by a communication device in accordance with some embodiments;

FIG. 7 is a flow chart illustrating an example of operations performed by a communication device in accordance with some embodiments;

FIG. 8 is a flow chart illustrating an example of operations performed by a communication device in accordance with some embodiments;

FIG. 9 is a flow chart illustrating an example of operations performed by a communication device in accordance with some embodiments;

FIG. 10 is block diagram depicting a communication device according to embodiments herein;

FIG. 11 is a block diagram of a communication system in accordance with some embodiments;

FIG. 12 is a block diagram of a user equipment in accordance with some embodiments

FIG. 13 is a block diagram of a network node in accordance with some embodiments;

FIG. 14 is a block diagram of a host computer communicating with a user equipment in accordance with some embodiments;

FIG. 15 is a block diagram of a virtualization environment in accordance with some embodiments; and

FIG. 16 is a block diagram of a host computer communicating via a base station with a user equipment over a partially wireless connection in accordance with some embodiments in accordance with some embodiments.

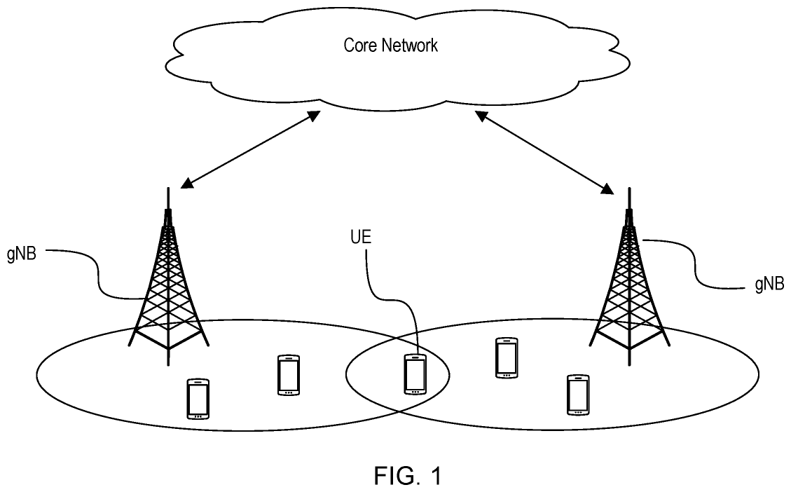

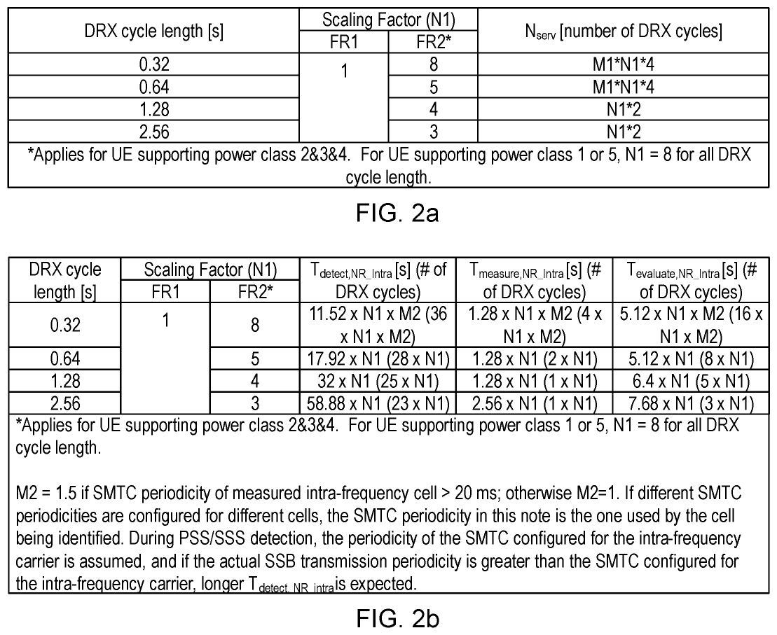

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present concepts to those skilled in the art. It should also be noted that these embodiments are not mutually exclusive. Components from one embodiment may be tacitly assumed to be present/used in another embodiment.

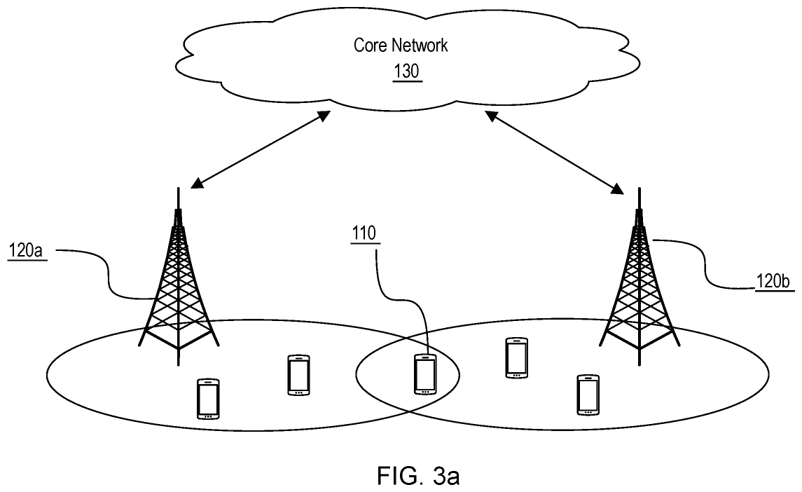

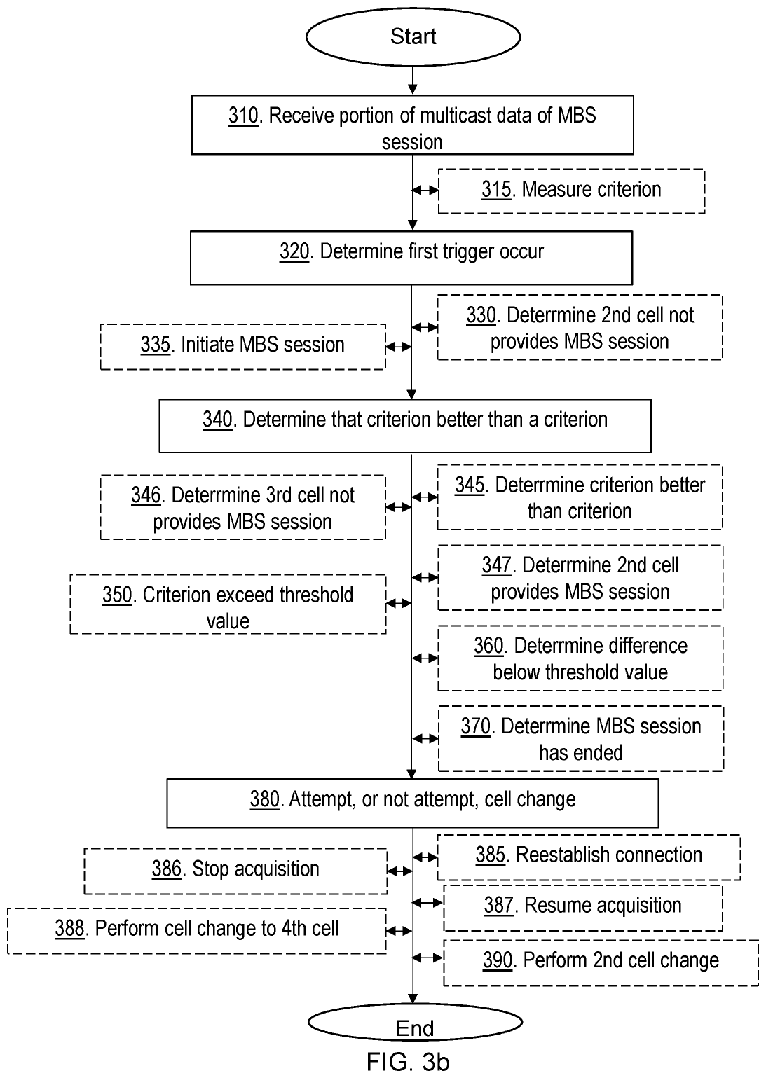

FIG. 3a illustrates an example of a NR network, e.g., a 5th Generation (5G) network, including a 5G core (5GC) network 130, network nodes 120a-b, e.g., 5G base station “gNBs”, multiple communication devices 110, also referred to as user equipment (UE).

In some examples, the term “node” can be used herein to refer to a network node or a communication device, also referred to herein as a user equipment (“UE”).

In additional or alternative examples, the term “network node” can be used herein to refer to NodeB, base station (BS), multi-standard radio (MSR) radio node such as MSR BS, eNodeB, gNodeB. master eNB (MeNB), secondary eNB (SeNB), location measurement unit (LMU), integrated access backhaul (IAB) node, network controller, radio network controller (RNC), base station controller (BSC), relay, donor node controlling relay, base transceiver station (BTS), Central Unit, e.g., in a gNB, Distributed Unit, e.g., in a gNB, Baseband Unit, Centralized Baseband, C-RAN, access point (AP), transmission points, transmission nodes, transmission reception point (TRP), RRU, RRH, nodes in distributed antenna system (DAS), core network node, e.g., MSC, MME, and AMF, O&M, OSS, SON, location server, e.g. LMF, E-SMLC, SUPL SLP. The location server may also be called a positioning node or positioning server.

In additional or alternative examples, the term communication device or “UE” can be used herein to refer to any type of wireless device communicating with a network node and/or with another UE in a cellular or mobile communication system. Examples of a communication device include a target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), and USB dongle.

In additional or alternative examples, the term “radio access technology (RAT)” can be used herein to refer to any RAT, for example, UTRA, E-UTRA, narrow band internet of things (NB-IoT), WiFi, Bluetooth, next generation RAT, NR, 4G, and 5G. Any of the equipment denoted by the term node, network node or radio network node may be capable of supporting a single or multiple RATs.

Examples of measurements are cell identification, e.g., PCI acquisition, PSS/SSS detection, cell detection, cell search etc, Reference Symbol Received Power (RSRP), Reference Symbol Received Quality (RSRQ), synchronization signal-RSRP (SS-RSRP), SS-RSRQ, SINR, RS-SINR, SS-SINR, CSI-RSRP, CSI-RSRQ, received signal strength indicator (RSSI), acquisition of system information (SI), cell global ID (CGI) acquisition, Reference Signal Time Difference (RSTD), communication device RX-TX time difference measurement, Radio Link Monitoring (RLM), which consists of Out of Synchronization (out of sync) detection and In Synchronization (in-sync) detection etc.

In additional or alternative examples, the term “Multicast/Broadcast function” can be used herein to refer to a Multicast/Broadcast communication, Multicast/Broadcast delivery, Multicast/Broadcast service (MBS), which can include broadcast service or multicast service. The broadcast communication service includes transmitting or providing or delivering the same data simultaneously to all communication devices in certain geographical area, which may include one or more cells. The multicast communication service includes transmitting or providing or delivering the same data simultaneously to a set of communication devices in certain geographical area, which may include one or more cells. The set of communication devices may be allowed or authorized to receive the data, for example, based on the subscription. In some examples, the term MBS refers to reception of the same data by at least 2 communication devices in certain geographical region. The geographical region may comprise one or more portions of a cell, one cell or multiple cells etc. Furthermore, MBS data may refer to multicast and/or broadcast data in MBS session.

In additional or alternative examples, the term “time resource” can be used herein to refer to any type of physical resource or radio resource expressed in terms of length of time. Examples of time resources include: symbol, time slot, subframe, radio frame, TTI, interleaving time, slot, sub-slot, mini-slot, SFN, and hyper-SFN (H-SFN).

Various embodiments herein relate to an environment in which a communication device is served by a first cell “cell1” and operating in a low activity radio resource control (RRC) state. Cell1 may belong to or operate on a first carrier frequency (F1). Cell1 may further be managed, served, or operated by a first network node (NN1). Examples of NN1 include a base station, transmission/reception point (TRP), access point, gNB, and eNB. Examples of a low activity RRC state include a RRC idle state and a RRC inactive state. In an RRC idle state, the communication device 110 presence may be known to the network, e.g., a core network, in a tracked area or registration area which includes one or multiple cells. In a RRC inactive state, the communication device presence may be known to the network, e.g., to a radio access network (RAN) or a core network, in RAN area level which may include one or multiple cells within the RAN area. In a low activity RRC state, the communication device 110 may be configured with a longer DRX cycle, e.g., DRX cycle of 320 ms or longer. In a low activity RRC state, the communication device 110 can be further configured to perform measurements on a serving cell and one or more neighbour cells, e.g., also called as non-serving cells, with lower activity or infrequently, e.g., once every Kth DRX cycle, where K≥1, and examples of K include K=1 or K=2. The communication device 110 may perform measurements on neighbour cells when the serving cell signal level, e.g., RSRP or RSRQ, falls below a threshold. The communication device 110 may further be triggered to autonomously perform a cell change, e.g., cell selection or cell reselection. For example, the communication device 110 may be configured via broadcast message, e.g., via system information (SI) such as SIB1 or SIB2, with one or more carrier frequency on which the communication device 110 can perform the cell change.

FIG. 3b discloses a flowchart illustrating a method of operating the communication device 110 of the communications network.

Action 310. The communication device 110 receives a portion of multicast data of a multicast and broadcast services, MBS, session via a first cell of the communications network while the communication device is in a low power state. The lower power state may comprise a radio resource control, RRC, idle state or a RRC inactive state.

Action 315. The communication device 110 may measure a criterion associated with the first cell and a criterion associated with neighbouring cells while the communication device is in the low power state.

Action 320. The communication device 110 determines that a first trigger for performing a cell change has occurred. The communication device 110 may determine that the first trigger for performing the cell change has occurred by determining that the criterion associated with a neighbour cell exceeds the criterion associated with the first cell by a threshold amount. The communication device 110 may determine that the first trigger for performing the cell change has occurred by receiving a message from the communications network instructing the communication device to perform the cell change.

Action 330. The communication device 110 may, prior to attempting the cell change, determine that a second cell is not providing the MBS session.

Action 335. The communication device 110 may prior to attempting the cell change, determine that the second cell is not providing the MBS session; and prior to completion of the cell change, initiate a MBS session establishment procedure to cause the second cell to provide the MBS session. For example, the communication device 110 may initiate the MBS session establishment procedure by transmitting a request to initiate the MBS session establishment procedure to the first cell or the second cell.

Action 340. The communication device 110 determines that a criterion associated with the second cell is better than a criterion associated with the first cell.

Action 345. The communication device 110 may prior to attempting the cell change, determine that a criterion associated with a third cell is better than the criterion associated with the second cell.

Action 346. The communication device 110 may prior to attempting the cell change, determine that the third cell is not providing the MBS session.

Action 347. The communication device 110 may prior to attempting the cell change, determine that the second cell is providing the MBS session.

Action 350. The communication device 110 may, subsequent to determining that the first trigger has occurred and prior to determining that the MBS session has ended, determine that the criterion associated with the first cell exceeds a threshold value. The threshold value may be based on at least one of: a predefined threshold value; and an indication of a value received from the communications network. The criterion associated with the first cell may comprise at least one of: a received signal level at the communication device 110 from the first cell; a signal quality of MBS data associated with the MBS session; and a reception quality of the MBS data associated with the MBS session. The received signal level may comprise at least one of: a reference signal received power (RSRP); a reference signal received quality (RSRQ); a cell selection received level value, S_{rxley}; and a cell selection quality value, S_{qual}, wherein the signal quality of the MBS data may comprise at least one of: a signal to noise ratio (SNR); and a signal to interference and noise ratio (SINR), and wherein the reception quality of the MBS data may comprise at least one of: a bit error rate (BER); and a block error rate (BLER).

Action 360. The communication device 110 may, subsequent to determining that the first trigger has occurred and prior to determining that the MBS session has ended, determine that a difference between the criterion associated with the second cell and the criterion associated with the first cell is below a threshold value. The threshold value may be based on at least one of: a predefined threshold value; and an indication of a value received from the communications network.

Action 370. The communication device 110 may, subsequent to determining that the first trigger has occurred, determine that the MBS session has ended.

Action 380. The communication device 110 attempts, or not attempts, the cell change from the first cell to the second cell, taking into account whether MBS is supported by the second cell and/or whether an MBS session is already provided in the second cell. The communication device 110 may attempt the cell change by, responsive to determining that the MBS session has ended, attempting the cell change.

Action 385. The communication device 110 may, wherein attempting the cell change comprises failing to perform the cell change from the first cell to the second cell, and responsive to failing to perform the cell change, reestablish a connection with the first cell.

Action 386. The communication device 110 may further, responsive to reestablishing the connection with the first cell, stop acquisition of MBS data from the MBS session from the first cell.

Action 387. The communication device 110 may further, responsive to reestablishing the connection with the first cell, resume acquisition of MBS data from the MBS session from the first cell.

Action 388. The communication device 110 may further, wherein attempting the cell change comprises failing to perform the cell change from the first cell to the second cell, and responsive to failing to perform the cell change, perform a cell change to a fourth cell that provides the MBS session.

Action 390. The communication device 110 may, when the cell change is a first cell change and subsequent to successfully performing the first cell change, determine that the MBS session had ended; and may perform a second cell change from the second cell to the third cell.

In some embodiments, the communication device 110 performs the cell change when one or more triggering conditions or criteria are met. The one or more criteria can be pre-defined or the communication device 110 may be configured by the network node, e.g., by NN1. For example, the criterion for triggering, performing, or initiating cell change to another cell, e.g., cell2, may be based on a relation or comparison between received signal level of cell1 at the communication device 110 and a signal level threshold (H1), and/or a relation/comparison between received signal level of cell2 at the communication device 110 and a signal level threshold (H2). Cell2 may operate or belong to F1 or to another carrier frequency, e.g., F2. The relation or comparison may further be determined, performed, or evaluated over certain time period or interval, e.g., cell reselection time interval. In some examples, the criterion for performing the cell change to cell2 is met provided that the received signal level of cell2 is above H1, during a time interval, T1. In additional or alternative examples, the criterion for performing cell change to cell2 is met provided that the received signal level of cell1 is below H1, and the received signal level of cell2 is above H2, during a time interval, T2. The relation or comparison may further be determined, performed, or evaluated for one or multiple received signal level parameters by comparing them with their respective thresholds over a time interval. In some examples, the received signal level includes signal strength or signal quality. In additional or alternative examples, signal strength includes signal strength measurement (SSM) value, a signal strength parameter (SSP) which is function of SSM value. In additional or alternative examples, signal quality includes signal quality measurement (SQM), a signal quality parameter (SQP) which is function of SQM. In additional or alternative examples, SSM include path loss, RSRP, and SS-RSRP. In additional or alternative examples, SSP includes Sᵣₓₗₑᵥ. In additional or alternative examples, SQM includes RSRQ, SS-RSRQ, SNR, SINR. In additional or alternative examples, SQP includes S_{qual}.

In additional or alternative embodiments, the criterion for triggering, performing, or initiating cell change to another cell is based on whether the communication device 110 is unable to perform measurement on cell1 for certain number of discontinuous reception (DRX) cycles. In some examples, the communication device 110 initiates measurement on another cell, e.g. cell2, if the communication device 110 is unable to perform one or more measurements on cell1 during Ns number of DRX cycles, e.g., when communication device 110 cannot receive the serving cell signals. The parameter Ns may further depend on the DRX cycle and/or on the RS periodicity, e.g., Synchronization and Signal Block based measurement timing configuration SMTC period, and/or on beam sweeping factor in FR2.

In additional or alternative embodiments, the criterion for triggering, performing, or initiating cell change to another cell is based on whether the communication device 110 is also unable to identify a new cell after the communication device 110 was unable to measure on the serving cell for certain number of DRX cycles. In some examples, if the communication device 110 is unable to find any new suitable cell, e.g., cell2, based on searches and measurements using the intra-frequency, inter-frequency and inter-RAT information indicated in the system information for certain time period, e.g., 10 s, then the communication device 110 may initiate cell selection procedures, e.g., to yet another cell, for example, to cell3, for the selected PLMN.

In some examples, the communication device 110 in low activity RRC state, e.g., RRC_INACTIVE state, while receiving MBS data, receives MBS data from the current serving cell, a first serving cell (cell1), in low activity RRC state, e.g. RRC_INACTIVE state. In additional or alternative examples, the communication device 110 in low activity RRC state, e.g., RRC_INACTIVE state, while receiving MBS data, is autonomously configured to perform a cell change, e.g., cell reselection, to a second cell (cell2) based on one or more criteria.

In additional or alternative embodiments, the communication device 110 may be configured to receive the MBS data via higher layer configuration message, for example, MBS session information via a control channel such as multicast control channel (MCCH). The message may be sent via SI, e.g., in a SIB. The message may be sent in a dedicated signalling, e.g., via RRC message such as RRCReconfiguration or RRCRelease, before the communication device 110 enters low activity RRC state. The MBS session information can include scheduling of MBS on data channel, e.g., carrier frequency, cell ID, MBS session ID, physical resources such as time-frequency resources or resource blocks for MCCH, etc. The communication device 110 may receive the MBS session configuration message from NN1 or from another network node.

In additional or alternative embodiments, an objective is to enable the communication device 110 to continue receiving the multi-cast data and preferably complete the reception of the ongoing multi-cast data, e.g., complete the session, with no impact or minimal impact due to the cell change procedure.

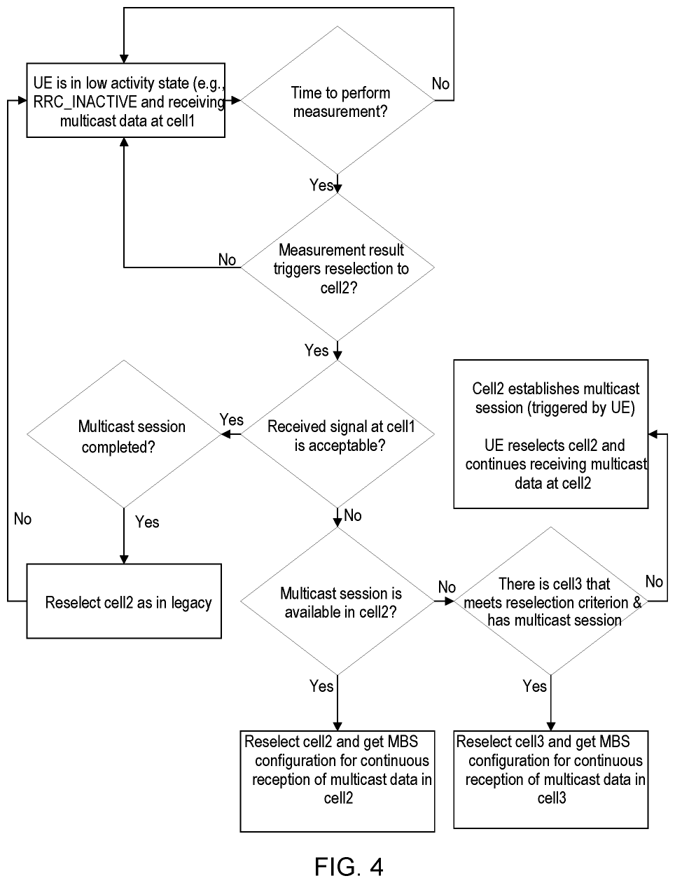

In some examples, to support reception of multicast data for the communication device 110 in low activity RRC state, e.g., RRC_INACTIVE communication devices, the cell change procedure, e.g., cell reselection procedure, may be updated, modified, or adapted. FIG. 4 is a flowchart illustrating operations for cell reselection with multicast reception.

In additional or alternative embodiments, to support the measurement and re-selection process considering the availability of multicast transmission at neighbouring cells, the current serving cell can provide RRC_INACTIVE communication devices with information about neighbouring cells that are providing the same ongoing multicast session(s). This can be done upon releasing the communication device 110 from RRC_CONNECTED to RRC_INACTIVE, e.g., including a list of such cells in the RRCRelease message. For example, current serving cell may include such information as part of the cellReselectionPriorities information element of the RRCRelease message. In additional or alternative embodiments, the current serving cell can broadcast this type of information in a system information block (SIB), for example, for each of a multicast session, there is a corresponding list of neighbouring cells that also provide the session.

Embodiments that include delaying or postponing cell change to a target cell are described below.

In some embodiments, to enable the communication device 110 to continue receiving the same multicast session(s) as much/long as possible from the current serving cell (cell1), the communication device 110 delays/postpones the cell change, e.g., the cell reselection procedure, to the target cell (cell2), e.g., the strongest cell, provided that one or more conditions or criteria are met.

In some examples, the condition is met provided that the reception quality of received signal at the communication device 110 from the current cell (cell1) is still within an acceptable range. The reception quality of the signal can be considered to still be acceptable if the received signal level, e.g., RSRP, RSRQ, Sᵣₓₗₑᵥ, S_{qual}, at the communication device 110 from the serving cell (cell1) remains above a certain threshold (H3). The threshold (H3) can be defined based on existing threshold(s) used in NR with a configurable offset value and can be provided to communication device 110 via common signalling, such as SIB signalling, or dedicated signalling such as RRC signalling.

In additional or alternative examples, the communication device 110 delays or postpones the cell change, e.g., cell reselection, to cell2 until the ongoing multicast session(s) is completed.

In additional or alternative examples, the communication device 110 delays or postpones the cell change, e.g., cell reselection, to cell2 until at least certain time period (T3) from the moment the cell change is triggered. T3 may be determined by a rule. In one example of the rule T3 may be pre-defined or T3 may be configured by the network node or T3 may comprise X1% of the duration of the MBS session, where X1 can be pre-defined or configured by the network node.

In additional or alternative examples, the communication device 110 delays or postpones the cell change until the received signal level at the communication device 110 from cell1 becomes equal to or falls below another threshold (H4). In additional or alternative examples H3=H4.

In additional or alternative examples, the communication device 110 delays or postpones the cell change until the reception quality of the MBS data is within an acceptable limit. In one example the reception quality of the MBS data is within an acceptable limit provided that the signal quality, e.g., SINR, SNR, of the MBS data is above certain threshold (H5). In another example the reception quality of the MBS data is within an acceptable limit provided that the error rate, e.g., BLER, BER, transport block error rate, message error rate, of the MBS data is below certain threshold (H6). H5 and H6 here can be pre-defined or configured by the network node.

In additional or alternative examples, the communication device 110 delays the cell reselection to the second cell until the ongoing multicast session is complete provided that the received signal level of the first cell, e.g., RSRP, RSRQ, Sᵣₓₗₑᵥ, S_{qual}, remains above certain threshold(s) and the second cell does not currently transmit the same MBS session(s) as in the first cell, or if there is the same MBS session(s) available in the second cell, it has been completed or about to complete. The communication device 110 may determine whether cell2 is transmitting the same MBS session based on one or more of: receiving information about MBS session in cell2 from another cell e.g. from cell1, based on pre-configured information, e.g. configured on the communication device SIM or USIM card etc, by reading system information (SI) of cell2 etc. For example, before cell change to cell2 the communication device 110 may read SI of cell2 and determine information about the MBS session transmitted in cell2. The threshold(s) can be defined based on existing threshold(s) used in NR with a configurable offset value and can be provided to communication device 110 via common signalling such as SIB signalling or dedicated signalling such as RRC signalling.

In additional or alternative examples, the communication device 110 determines whether a candidate target cell is within its current RNA. If the RNA is the same, the communication device 110 can reuse the MBS configuration, or group-common configuration via, for example, MCCH, it has received from the source cell to continue receiving the MBS session in the target cell, provided the MBS session is currently transmitted there. If the RNA of the target cell is different, and/or the multicast configuration is not provided via group-common signalling, such as MCCH, the communication device 110 may postpone the reselection to the target cell, to avoid the otherwise required reconfiguration, e.g., via RRC or group-common, in the target cell. The communication device 110 may postpone the reselection to a target cell in another RNA area for a certain time period (T3) or until the completion of ongoing multicast session(s). The communication device 110 may therefore apply a delay, before making the cell reselection, as a function of whether the candidate target cell is within the same RNA or not.

In additional or alternative examples, during the delayed period the communication device 110 continues receiving the MBS session from cell1. The communication device 110 performs cell change (e.g., reselects) to the cell2, upon completion of the multicast session(s) or if one or more of the above criteria is not met.

Embodiments that include performing the cell change to a cell providing a multicast session is described below.

In some embodiments, instead of delaying the cell change procedure, e.g., cell reselection procedure, the communication device 110 performs the cell change, e.g., cell reselection, to a third cell (cell3), which is also currently transmitting the same MBS session(s) as in the first cell provided that the third cell meets cell reselection criteria. For example, its received signal level at the communication device 110 is above certain threshold(s), e.g., above H7. However, the received signal level of the third cell at the communication device 110 may or may not be as strong as that of the second cell at the communication device 110.

In some examples, the communication device 110 may determine the third cell autonomously, e.g., during measurement procedure, or based on an indication received from the network e.g., from the first cell. In additional or alternative examples, the threshold(s) can be defined based on existing threshold(s) used in NR with a configurable offset value and can be provided to communication device 110 via common signalling such as SIB signalling or dedicated signalling such as RRC signalling.

In additional or alternative embodiments, the communication device 110 is allowed to continue receiving the MBS session even after the cell change to cell3 without a need of setting up the MBS session at target cell. In some examples, the communication device 110 continues to be served by cell3 even if the ongoing MSB session is completed. In additional or alternative examples, the communication device 110 performs cell change to another cell, e.g., a fourth cell (cell4), from cell3 after the ongoing MSB session is completed. In additional or alternative examples, cell4 is the same as cell1. In additional or alternative examples, cell4 is any cell which meets one or more cell change criteria. Examples of criteria for cell4 meeting the cell change criteria may include one or more of the following: if it is received signal level at the communication device 110 is largest among all the measured cells; if it is received signal level is above certain threshold; and if it is received signal level is above that of cell3 by certain margin.

Embodiments that include performing a cell change to a target and requesting a multicast session are described below.

In some embodiments, the cell upon triggering a cell change, e.g., to cell2, does not delay or postpone the cell change to cell2 but instead the communication device 110 performs the cell change cell2 and further initiates a procedure, which enables the establishment of the ongoing MBS session in cell2. The MBS session establishment procedure may be initiated by the communication device 110 and/or completed before or during the cell change procedure to cell2. In some examples, this allows the communication device 110 to continue the ongoing MBS session after the cell change to cell2.

In additional or alternative embodiments, the communication device 110 initiates the MBS session establishment procedure whenever the cell change is triggered to a target cell when the target cell does not provide the same MBS session as in the previous serving cell. In some examples, the communication device 110 initiates the MBS session establishment procedure in response to one of the above embodiments not being possible, e.g., if the received signal level of the first cell at the communication device 110 is below certain threshold, MBS data reception quality at the communication device 110 in cell1 is below threshold, or there is no such third cell in the area, which can provide the same MBS session as in cell1.

In additional or alternative embodiments, the MBS session establishment procedure in a target cell (cell2) includes a procedure in which the communication device 110 contacts the network, e.g., NN1, and requests the establishment of the MBS session(s) at the second cell (cell2).

In some examples, the communication device 110 can access to the current serving cell (cell1) that in turn requests cell2 (via Xn signalling) to establish the MBS session(s). An indication from communication device 110 to the first cell about its intention to select the second cell is needed given that communication device 110 needs to get new MBS configuration at the second cell. The indication may include for example information about the ongoing MBS session, which communication device 110 needs to receive in cell2 e.g. MBS session identifier. The communication device 110 may further indicate, e.g., include in the indication, the timing information regarding the start of the MBS session in cell2. The timing information may be reference time when the communication device 110 is expected to complete the cell change to cell2. In one example the reference time can be expressed in terms of absolute time such as Universal Time Coordinated (UTC) time. In another example the reference time can be expressed in terms of cell timing of a cell such as one or more system frame number (SFN), H-SFN, subframe number etc. Cell1 may in turn indicate cell2 about the starting reference time of the MBS session in cell2. The communication device 110 may send the indication or request to cell1 using one or more of the following mechanisms or procedures. The communication device 110 may further be configured based on pre-defined rule or by the network node, e.g., NN1, to use a particular mechanism or procedure for sending the indication or message to the network, e.g., to cell1.

In some examples, the indication can be realized through the resume procedure, such as an indication in the RRCResumeRequest message using some unused bits therein.

In additional or alternative examples, the indication from the communication device 110 may also be incorporated into the RNA update procedure, which does not necessarily bring the communication device 110 to Connected state.

In additional or alternative examples, the communication device 110 may send an indication or message to cell1 using small data transmission (SDT) mechanism. The communication device 110 may further be configured to use particular type of SDT mechanism to send the indication to cell1. In one example, the communication device 110 is configured to send the indication using random access channel (RACH) based SDT mechanism. In another example, the communication device 110 is configured to send the indication using configured grant (CG) based SDT mechanism. In another example, the communication device 110 is configured to send the indication using any SDT mechanism with which the communication device 110 may send the indication as early as possible. The communication device 110 transmits a message or indication in the cell (e.g. cell1) using SDT mechanism during any of the SDT configured occasions and using the configured SDT resources.

In additional or alternative examples, the communication device 110 continues data reception at current cell and only reselects to the second cell after the session is established. Once the session is established, cell1 can page the communication device 110 to indicate that reselection to cell2 can be done. A new Xn procedure can be defined so that cell1 and cell2 may communicate regarding the request and acknowledgment about establishment of a multicast session. In addition, the paging message, e.g., CN paging and/or RAN paging, can be extended to have such an indication, e.g., 1-bit flag to indicate communication device 110 that the multicast session on request has been successfully established at cell2.

In additional or alternative examples, the communication device 110 may directly access the second cell and indicate to cell2 that it expects to continue receiving the MBS sessions. In this case the MBS session establishment procedure in the target cell (cell2) is not initiated via cell1 rather directly by sending request to cell2. Such an indication can be done via an uplink message during the resume procedure, e.g., the RRCResumeRequest message or RRCResumeComplete message.

Embodiments that handle communication device 110 behaviour under a cell change failure are described below.

In some embodiments, the communication device 110, while receiving MBS session in cell1, is triggered to perform cell change to another cell (cell2) but the communication device 110 is unable to successfully perform the cell change to the target cell. This can be referred to as a cell change failure or a cell reselection failure. In some examples, the cell change failure occurs if the target cell is barred for the communication device 110. For example, the communication device 110 may determine whether the target cell is barred or not by acquiring the SI of the target cell at or during the cell change procedure. In this example, the communication device 110 may acquire the MBS session according to one or more of the following rules.

In some examples, the communication device 110 stops or suspends acquiring the MBS session from cell1 even if the communication device 110 reverts to cell1.

In additional or alternative examples, the communication device 110 resumes acquiring the MBS session from cell1 if the communication device 110 reverts to cell1.

In additional or alternative examples, the communication device 110 does not acquire the MBS session from a cell until the communication device 110 has successfully perform the cell reselection to a target cell.

In additional or alternative examples, the communication device 110 may perform cell change to another cell (cell3) different from the indicated one (cell2) given cell3 is not barred (communication device 110 knows this from acquiring SI), has ongoing MBS session(s), and meets one or more of the following cell reselection criteria, i.e., its received signal level at the communication device 110 is above certain threshold(s) e.g., above H8. This allows the communication device 110 to continue receiving the MBS session at cell3.

In additional or alternative embodiments, the communication device 110, while receiving MBS session in cell1, determines that the communication device 110 does not meet the cell selection criterion for cell1, e.g., serving cell signal strength and/or signal quality fall below their respective thresholds. Even if the cell selection criterion for cell1 is not met, the communication device 110 may still be able to acquire MBS data, e.g., with lower quality or with acceptable quality assuming lower modulation and coding scheme (MCS) is used, e.g., lower order modulation such as Quadrature phase shift keying (QPSK) and/or lower code rate such as ⅓ or lower. In this case the communication device 110 is further triggered to perform measurements on cells of all configured carriers regardless of the measurement rules. In this case the communication device 110 may acquire the MBS session according to one or more of the following rules.

In some examples, the communication device 110 stops or suspends acquiring the MBS session from cell1. This in turn allows the communication device 110 to spend its resources for performing measurements on cells.

In additional or alternative examples, the communication device 110 is still allowed or required to acquire the MBS session from cell1 provided that the reception quality of the MBS data is within acceptable level. In this case the communication device 110 still performs measurements on other cells. This in turn allows the communication device 110 to complete the MBS session as much as possible.

In additional or alternative examples, the communication device 110 is still allowed or required to acquire the MBS session from cell1 provided that the reception quality of the MBS data is within acceptable level. But in addition, the communication device 110 is allowed to relax the measurements on other cells e.g., the communication device 110 can extend the measurement period by certain margin. This in turn allows the communication device 110 to complete the MBS session as much as possible while also performing measurements on as many cells as possible but over longer time period.

In additional or alternative examples, if the communication device 110 is unable to find any suitable cell after measurements and searches on other cells, then the communication device 110 may perform or initiate the cell selection procedure to the selected PLMN. In this example, the communication device 110 may acquire the MBS session according to one or more of the following rules.

In some examples, the communication device 110 stops acquiring the MBS session from cell1 or stops any attempt to acquire the MBS session from cell1. This in turn allows the communication device 110 to spend its resources for performing cell selection to the selected PLMN.

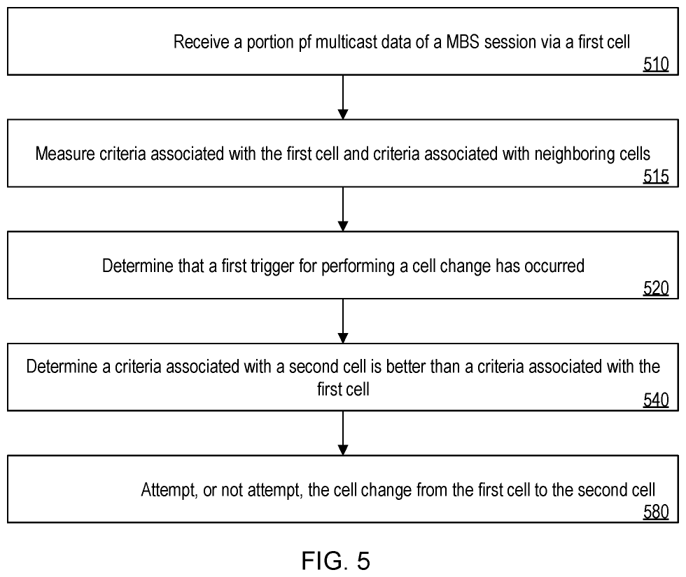

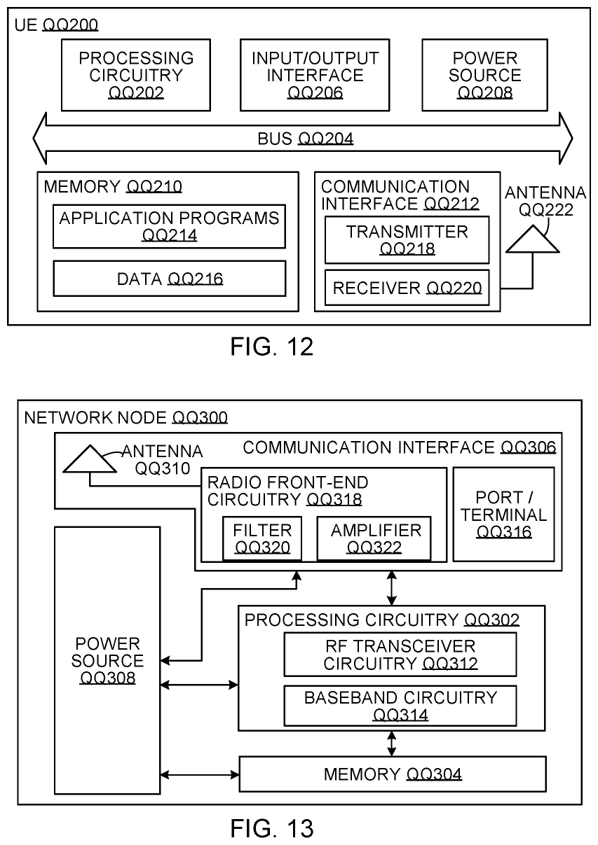

In the description that follows, while the communication device 110 may be any of communication device QQ112A-D, QQ200, hardware QQ504, or virtual machine QQ508A, QQ508B, the communication device QQ200 shall be used to describe the functionality of the operations of the communication device 110. Operations of the communication device QQ200 (implemented using the structure of FIG. 12) will now be discussed with reference to the flow charts of FIGS. 5-9 according to some embodiments of inventive concepts. For example, modules may be stored in memory QQ210 of FIG. 12, and these modules may provide instructions so that when the instructions of a module are executed by respective communication device processing circuitry QQ202, processing circuitry QQ202 performs respective operations of the flow charts.

FIG. 5 illustrates an example of operations performed by the communication device 110 of a communications network.

At block 510, processing circuitry QQ202 receives, via communication interface QQ212, a portion of multicast data of a MBS session via a first cell. In some embodiments, the portion of the MBS session is received while the communication device is in a low power state. In some examples, the low power state includes a RRC idle state or a RRC inactive state. In additional or alternative embodiments, the communication device is in the low power state during all of the operations of FIGS. 5-9.

At block 515, processing circuitry QQ202 measures one or more criteria associated with the first cell and one or more criteria associated with neighbouring cells.

At block 520, processing circuitry QQ202 determines that a first trigger for performing a cell change has occurred. In some embodiments, determining that the first trigger for performing the cell change has occurred includes determining that a criterion associated with a neighbour cell exceeds the criterion associated with the first cell by a threshold amount. In additional or alternative embodiments, determining that the first trigger for performing the cell change has occurred includes receiving a message from the communications network instructing the communication device to perform the cell change.

At block 540, processing circuitry QQ202 determines a criterion associated with a second cell is better than a criterion associated with the first cell. In some embodiments, the criterion, associated with the first cell, the second cell, or another neighbouring cell, includes at least one of: a received signal level; a signal quality of MBS data associated with the MBS session; and a reception quality of the MBS data associated with the MBS session. In some examples, the received signal level includes at least one of: a RSRP; a RSRQ; a cell selection received level value, S_{rxley}; and a cell selection quality value, S_{qual}. In additional or alternative examples, the signal quality of the MBS data includes at least one of: a SNR; and a SINR. In additional or alternative examples, the reception quality of the MBS data includes at least one of: a BER; and a BLER.

At block 580, processing circuitry QQ202 attempts, or not attempts, the cell change from the first cell to the second cell, taking into account whether MBS is supported by the second cell and/or whether an MBS session is already provided in the second cell.

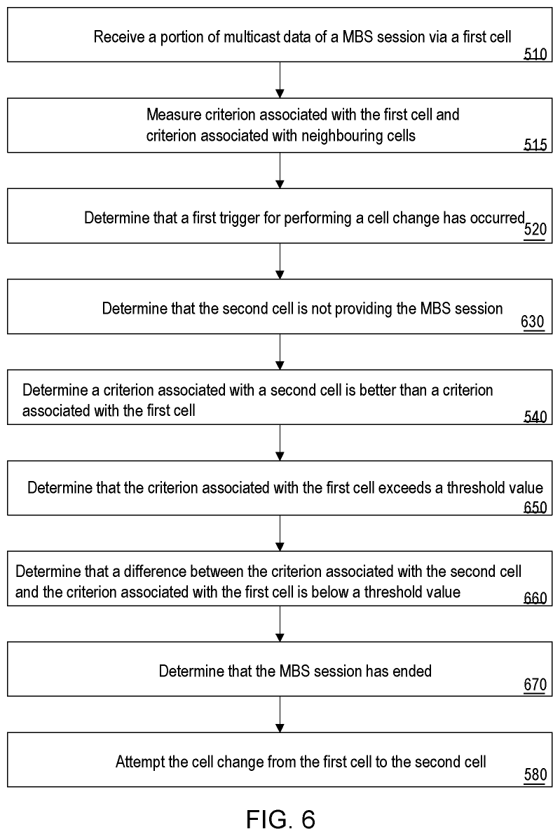

FIG. 6 illustrates an example of operations performed by the communication device 110 of the communications network. In this example, the communication device delays changing from the first cell to a second cell. The operations of FIG. 6 may include all of the operations of FIG. 5. In other examples, the operations of FIG. 6 may include only a portion of the operations of FIG. 5.

At block 630, processing circuitry QQ202 determines that the second cell is not providing the MBS session. In some embodiments, the second cell is determined to not provide the MBS session prior to the communication device attempting the cell change.

At block 650, processing circuitry QQ202 determines that the one or more criteria associated with the first cell exceeds a threshold value. In some embodiments, the communication device determines that the one or more criteria associated with the first cell exceeds a threshold after determining that the first trigger has occurred and prior to determining that the MBS session has ended. In alternative embodiments, if the communication device determines that the one or more criteria associated with the first cell has fallen below the threshold after determining that the first trigger has occurred and prior to determining that the MBS session has ended, the communication device will proceed with performing the cell change (prior to the MBS session ending).

At block 660, processing circuitry QQ202 determines that a difference between the criterion associated with the second cell and the criterion associated with the first cell is below a threshold value. In some embodiments, the communication device 110 determines that the difference is below the threshold after determining that the first trigger has occurred and prior to determining that the MBS session has ended. In alternative embodiments, if the communication device 110 determines that the difference exceeds the threshold after determining that the first trigger has occurred and prior to determining that the MBS session has ended, the communication device will proceed with performing the cell change, prior to the MBS session ending.

In some embodiments either or both of the threshold values in blocks 660 and 670 can be predefined or determined based on an indication of a value received from the communications network.

At block 670, processing circuitry QQ202 determines that the MBS session has ended. In some embodiments, the communication device 110 continues to receive MBS data from the MBS session (until it ends) after determining that the first trigger has occurred. In additional or alternative embodiments, the communication device 110 may not attempt the cell change until the MBS session ends.

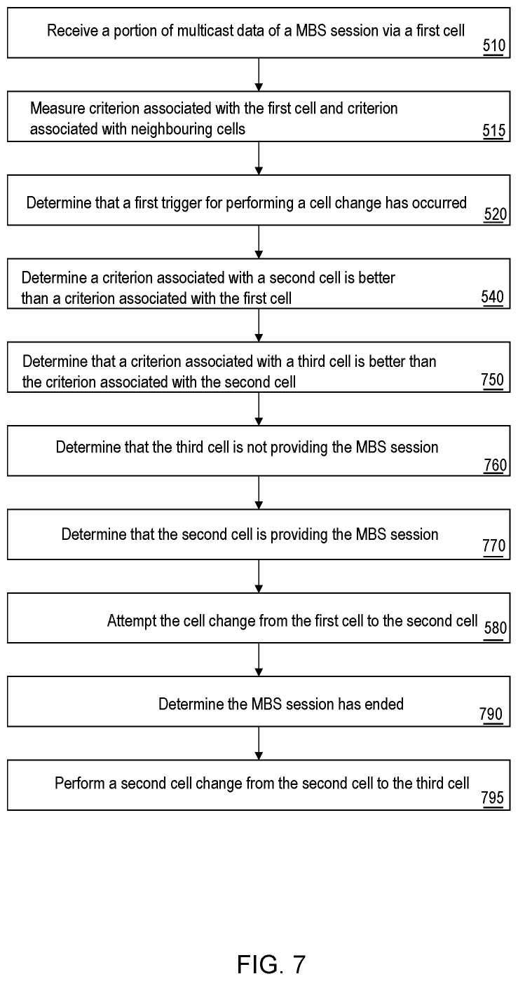

FIG. 7 illustrates an example of operations performed by a communication device of a communications network. In this example, the communication device changes from the first cell to a second cell that supports the MBS session despite the second cell not having the best criterion, e.g., reception quality or signal strength. The operations of FIG. 7 may include all of the operations of FIG. 5. In other examples, the operations of FIG. 7 may include only a portion of the operations of FIG. 5.

At block 750, processing circuitry QQ202 determines that a criterion associated with a third cell is better than the criterion associated with the second cell. In some embodiments, the communication device 110 determines that the criterion associated with the third cell is better than the criterion associated with the second cell prior to attempting the cell change.

At block 760, processing circuitry QQ202 determines that the third cell is not providing the MBS session. In some embodiments, the communication device 110 determines that the third cell is not providing the MBS session prior to attempting the cell change.

At block 770, processing circuitry QQ202 determines that the second cell is providing the MBS session. In some embodiments, the communication device 110 determines that the second cell is providing the MBS session prior to attempting the cell change.

At block 790, processing circuitry QQ202 determines that the MBS session has ended. In some embodiments, the communication device 110 determines that the MBS session has ended after performing the cell change to the second cell.

At block 795, processing circuitry QQ202 performs a second cell change from the second cell to the third cell.

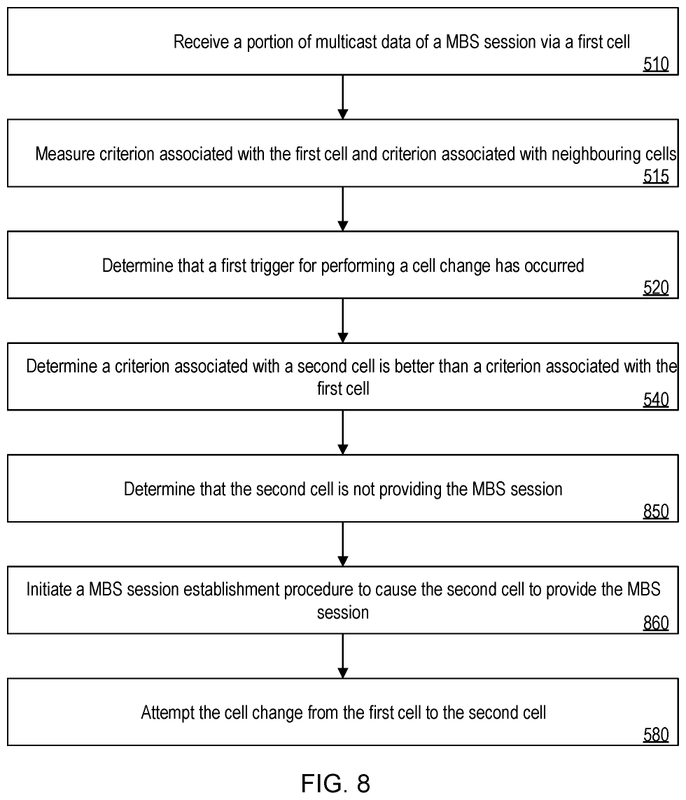

FIG. 8 illustrates an example of operations performed by the communication device 110 of the communications network. In this examples, the communication device 110 requests that the second cell provide the MBS session. The operations of FIG. 8 may include all of the operations of FIG. 5. In other examples, the operations of FIG. 8 may include only a portion of the operations of FIG. 5.

At block 850, processing circuitry QQ202 determines that the second cell is not providing the MBS session. In some embodiments, the communication device 110 determines that the second cell is not providing the MBS session prior to performing the cell change to the second cell.

At block 860, processing circuitry QQ202 initiates a MBS session establishment procedure to cause the second cell to provide the MBS session. In some embodiments, the communication device 110 initiates the MBS session establishment procedure prior to completing the cell change to the second cell. In some examples, initiating the MBS session establishment procedure includes transmitting a request to initiate the MBS session establishment procedure to the first cell. In additional or alternative examples, initiating the MBS session establishment procedure includes transmitting a request to initiate the MBS session establishment procedure to the second cell.

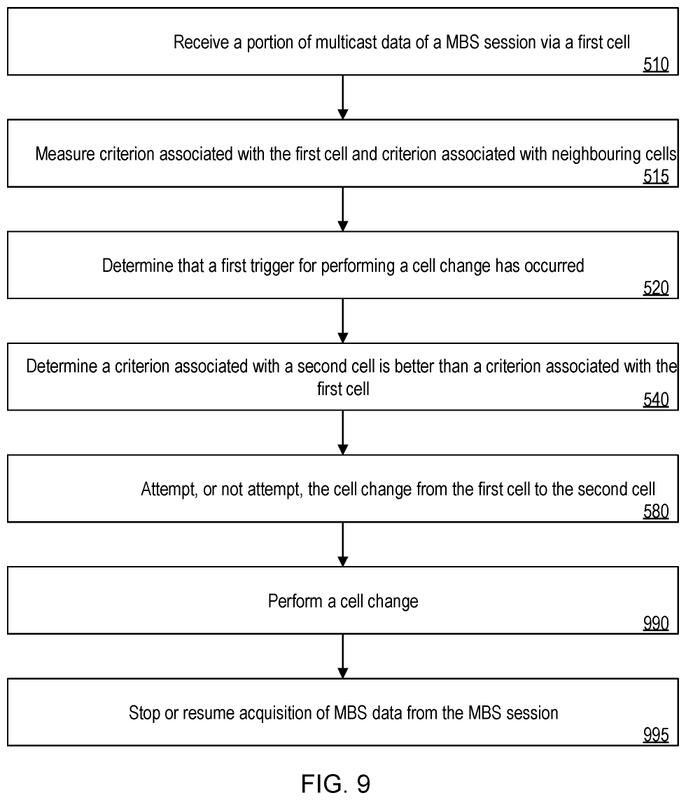

FIG. 9 illustrates an example of operations performed by a communication device of a communications network when the cell change fails. In this examples, the operations of FIG. 9 may include all of the operations of FIG. 5. In other examples, the operations of FIG. 9 may include only a portion of the operations of FIG. 5.

At block 990, processing circuitry QQ202 performs a cell change. In some embodiments, the communication device 110 reconnects to the first cell. In additional or alternative embodiments, the communication device 110 connects to another cell based on previously obtained measurements.

At block 995, processing circuitry QQ202 stops or resumes acquisition of MBS data from the MBS session.

Various operations of FIGS. 4-9 may be optional with respect to some embodiments.

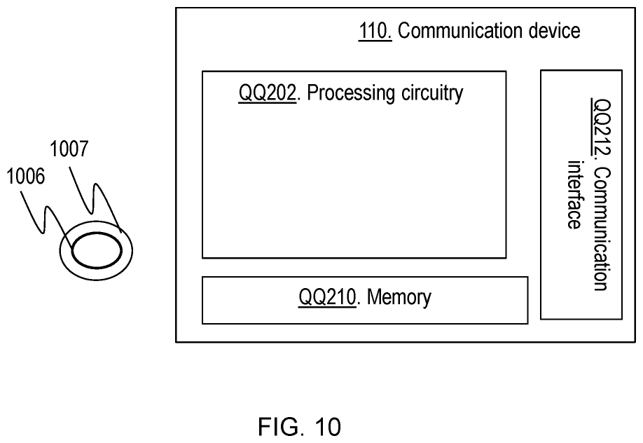

FIG. 10 is a block diagram depicting embodiments of the communication device 110 operating in the communications network according to embodiments herein.

The communication device 110 may comprise processing circuitry QQ202, e.g., one or more processors, configured to perform the methods herein.

The communication device 110 further comprises a memory QQ210. The memory comprises one or more units to be used to store data on. The second network node 200 comprises a communication interface QQ212 comprising transmitter, receiver, transceiver and/or one or more antennas.

Thus, it is herein disclosed the communication device 110 operating in the communications network, wherein the communication device 110 comprises processing circuitry and a memory QQ210 coupled to the processing circuitry and having instructions stored therein that are executable by the processing circuitry to cause the communication device to perform operations comprising any of the operations of embodiments herein.

The methods according to the embodiments described herein for the communication device 110 may be respectively implemented by means of e.g. a computer program 1007 or a computer program product, comprising program code to be executed by processing circuitry whereby execution of the program code causes the communication device to perform operations according to any of the embodiments herein. It is further herein provided a computer program product 1008 comprising a non-transitory storage medium including program code to be executed by processing circuitry of the communication device 110 operating in the communications network, whereby execution of the program code causes the communication device to perform operations according to any of the embodiments herein.

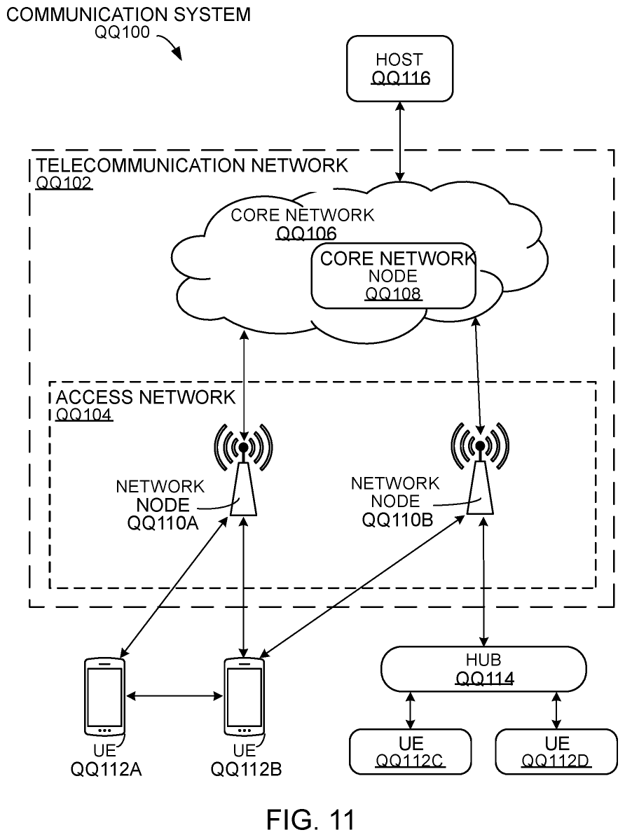

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110 or network node 120 above), or any other similar 3^{rd} Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112 or communication device 110 above) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub-that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

FIG. 12 shows a UE QQ200, being an example of the communication device 110, in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source, e.g., an electricity outlet, photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic, e.g., once every 15 minutes if it reports the sensed temperature, random, e.g., to even out the load from reporting from several sensors, in response to a triggering event, e.g., when moisture is detected an alert is sent, in response to a request, e.g., a user initiated request, or a continuous stream (e.g., a live video feed of a patient.

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information, obtained through a speed sensor, to a second UE that is a remote controller operating the drone. When the user makes changes from the remote controller, the first UE may adjust the throttle on the drone, e.g. by controlling an actuator, to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide, or, stated differently, their transmit power level, and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signalling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

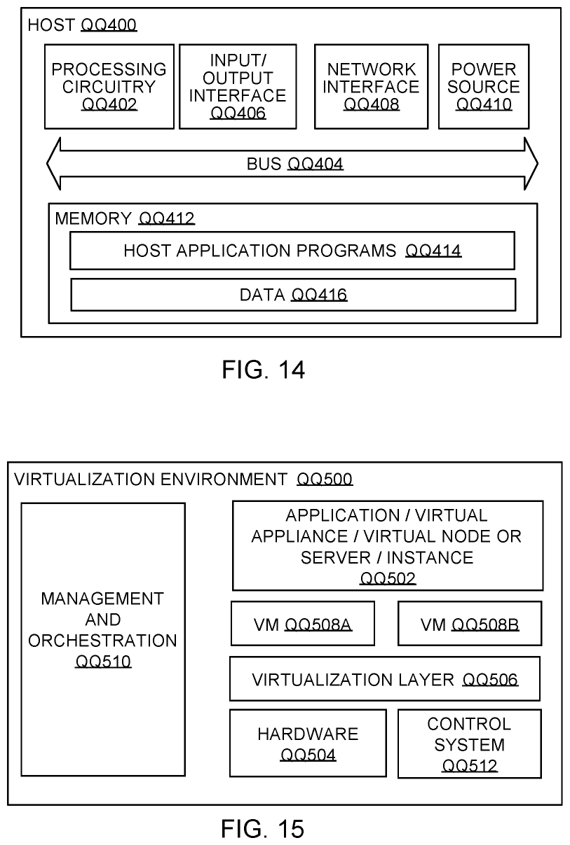

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 12 and 13, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system QQ512 which may alternatively be used for communication between hardware nodes and radio units.

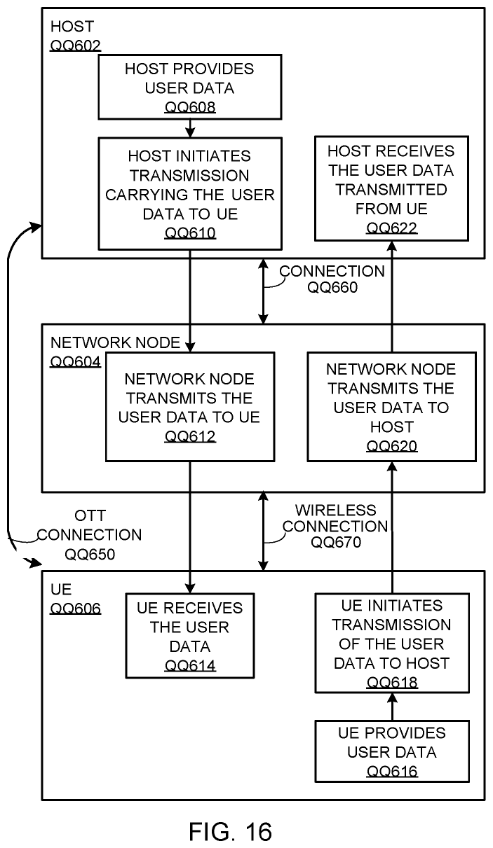

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may enable a UE transitioning from RRC_INACTIVE to RRC_CONNECTED to be able to resume/continue the reception of multicast MBS sessions by synchronizing its local PDCP state variables with the PDCP SN used in network side. Additional or alternative embodiments resolve possible ambiguity in PDCP operation at suspension of a multicast MRB. Some embodiments enable the UE to resume an RRC connection to receive possible missing multicast data while it was in RRC_INACTIVE for improved reliability. Additional or alternative embodiments enable continuity of reception for cases where the UE is released to RRC INACTIVE and continues receiving the same multicast session using a broadcast MRB. Additional or alternative embodiments enable continuity of reception for cases where the UE comes back to RRC CONNECTED to resume the multicast MRB after having received the same multicast session in RRC INACTIVE via a broadcast MRB.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signalling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiments

1. A method of operating a communication device of a communications network, the method comprising:
receiving (510) a portion of a multicast and broadcast services, MBS, session via a first cell of the communications network while the communication device is in a low power state;
determining (520) that a first trigger for performing a cell change has occurred;
determining (540) that a criterion associated with a second cell is better than a criterion associated with the first cell; and
attempting (580) the cell change from the first cell to the second cell.

2. The method of Embodiment 1, further comprising:
prior to attempting the cell change, determining (630) that the second cell is not providing the MBS session; and
subsequent to determining that the first trigger has occurred, determining (670) that the MBS session has ended,
wherein attempting the cell change comprises responsive to determining that the MBS session has ended, attempting the cell change.

3. The method of Embodiment 2, further comprising:
subsequent to determining that the first trigger has occurred and prior to determining that the MBS session has ended, determining (650) that the criterion associated with the first cell exceeds a threshold value.

4. The method of any of Embodiments 2-3, further comprising:
subsequent to determining that the first trigger has occurred and prior to determining that the MBS session has ended, determining (660) that a difference between the criterion associated with the second cell and the criterion associated with the first cell is below a threshold value.

5. The method of any of Embodiments 3-4, wherein the threshold value is based on at least one of:
a predefined threshold value; and
an indication of a value received from the communications network.

6. The method of Embodiment 1, further comprising:
prior to attempting the cell change, determining (750) that a criterion associated with a third cell is better than the criterion associated with the second cell;
prior to attempting the cell change, determining (760) that the third cell is not providing the MBS session; and
prior to attempting the cell change, determining (770) that the second cell is providing the MBS session.

7. The method of Embodiment 6, wherein the cell change is a first cell change,
the method further comprising:
   subsequent to successfully performing the first cell change, determining (790) the MBS session had ended; and
   performing (795) a second cell change from the second cell to the third cell.

8. The method of Embodiment 1, further comprising:
prior to attempting the cell change, determining (850) that the second cell is not providing the MBS session; and
prior to completion of the cell change, initiating (860) a MBS session establishment procedure to cause the second cell to provide the MBS session.

9. The method of Embodiment 8, wherein initiating the MBS session establishment procedure comprises transmitting a request to initiate the MBS session establishment procedure to the first cell.

10. The method of Embodiment 8, wherein initiating the MBS session establishment procedure comprises transmitting a request to initiate the MBS session establishment procedure to the second cell.

11. The method of any of Embodiments 1-10, wherein the criterion associated with the first cell comprises at least one of:
a received signal level at the UE from the first cell;
a signal quality of MBS data associated with the MBS session; and
a reception quality of the MBS data associated with the MBS session.

12. The method of Embodiment 11, wherein the received signal level comprises at least one of:
a reference signal received power, RSRP;
a reference signal received quality, RSRQ;
a cell selection received level value, S_{rxley}; and
a cell selection quality value, S_{qual},
wherein the signal quality of the MBS data comprises at least one of:
   a signal to noise ratio, SNR; and
   a signal to interference and noise ratio, SINR, and
wherein the reception quality of the MBS data comprises at least one of:
   a bit error rate, BER; and
   a block error rate, BLER.

13. The method of any of Embodiments 1-12, further comprising:
measuring (515) the criterion associated with the first cell and criterion associated with neighbouring cells while the communication device is in the low power state.

14. The method of any of Embodiments 1-13, wherein the lower power state comprises a radio resource control, RRC, idle state or a RRC inactive state.

15. The method of any of Embodiments 1-14, wherein attempting the cell change comprises failing to perform the cell change from the first cell to the second cell,
the method further comprising:
   responsive to failing to perform the cell change, reestablishing (990) a connection with the first cell; and
   responsive to reestablishing the connection with the first cell, stopping (995) acquisition of MBS data from the MBS session from the first cell.

16. The method of any of Embodiments 1-14, wherein attempting the cell change comprises failing to perform the cell change from the first cell to the second cell,
the method further comprising:
   responsive to failing to perform the cell change, reestablishing (990) a connection with the first cell; and
   responsive to reestablishing the connection with the first cell, resuming (995) acquisition of MBS data from the MBS session from the first cell.

17. The method of any of Embodiments 1-14, wherein attempting the cell change comprises failing to perform the cell change from the first cell to the second cell,
the method further comprising:
   responsive to failing to perform the cell change, performing (990) a cell change to a fourth cell that provides the MBS session.

18. The method of any of Embodiments 1-17, wherein determining that the first trigger for performing the cell change has occurred comprises:
determining that a criterion associated with a neighbour cell exceeds the criterion associated with the first cell by a threshold amount.

19. The method of any of Embodiments 1-17, wherein determining that the first trigger for performing the cell change has occurred comprises:
receiving a message from the communications network instructing the communication device to perform the cell change.

20. A communication device (QQ112A-D, QQ200, QQ504) operating in a communications network, the communication device comprising:
processing circuitry (QQ202); and
memory (QQ210) coupled to the processing circuitry and having instructions stored therein that are executable by the processing circuitry to cause the communication device to perform operations comprising any of the operations of Embodiments 1-19.

21. A computer program comprising program code to be executed by processing circuitry (QQ202) of a communication device (QQ112A-D, QQ200, QQ504) operating in a communications network, whereby execution of the program code causes the communication device to perform operations comprising any operations of Embodiments 1-19.

22. A computer program product comprising a non-transitory storage medium (QQ210) including program code to be executed by processing circuitry (QQ202) of a communication device (QQ112A-D, QQ200, QQ504) operating in a communications network, whereby execution of the program code causes the communication device to perform operations comprising any operations of Embodiments 1-19.

23. A non-transitory computer-readable medium having instructions stored therein that are executable by processing circuitry (QQ202) of a communication device (QQ112A-D, QQ200, QQ504) operating in a communications network to cause the communication device to perform operations comprising any of the operations of Embodiments 1-19.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Abbreviations

At least some of the following abbreviations may be used in this disclosure. If there is an inconsistency between abbreviations, preference should be given to how it is used above. If listed multiple times below, the first listing should be preferred over any subsequent listing(s).
5G 5th Generation
5GMM 5G Mobility Management
CN Core Network
DCI Downlink Control Indicator
gNB gNodeB
GGAI Geo-Group Area Identifier
LTE Long-Term Evolution
NAS Non-Access Stratum
NR New Radio
NSPS National Security and Public Safety
RAN Radio Access Network
RNA RAN Notification Area
RNTI Radio Network Temporary Identifier
TA Tracking Area
TAI Tracking Area Identifier
UE User Equipment
V2X Vehicle-to-anything communication
1x RTT CDMA2000 1x Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/NoCPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1. A method of operating a communication device of a communications network, the method comprising:
receiving a portion of multicast data of a multicast and broadcast services, MBS, session via a first cell of the communications network while the communication device is in a low power state;
determining that a first trigger for performing a cell change has occurred;
determining that a criterion associated with a second cell is better than a criterion associated with the first cell;
determining that a criterion associated with a third cell is better than the criterion associated with the second cell;
determining that the third cell is not providing the MBS session;
determining that the second cell is providing the MBS session; and
attempting, or not attempting, the cell change from the first cell to the second cell, taking into account one or both of whether MBS is supported by the second cell and whether an MBS session is already provided in the second cell.

2. The method of claim 1, further comprising:
prior to attempting the cell change, determining that the second cell is not providing the MBS session; and
subsequent to determining that the first trigger has occurred, determining that the MBS session has ended,
wherein attempting the cell change comprises responsive to determining that the MBS session has ended, attempting the cell change.

3. The method of claim 2, further comprising:
subsequent to determining that the first trigger has occurred and prior to determining that the MBS session has ended, determining that the criterion associated with the first cell exceeds a threshold value.

4. The method of claim 2, further comprising:
subsequent to determining that the first trigger has occurred and prior to determining that the MBS session has ended, determining that a difference between the criterion associated with the second cell and the criterion associated with the first cell is below a threshold value.

5. The method of claim 3, wherein the threshold value is based on at least one of:
a predefined threshold value; and
an indication of a value received from the communications network.

6. (canceled)

7. The method of claim 1, wherein the cell change is a first cell change, the method further comprising:
subsequent to successfully performing the first cell change, determining the MBS session had ended; and
performing a second cell change from the second cell to the third cell.

8. The method of claim 1, further comprising:
prior to attempting the cell change, determining that the second cell is not providing the MBS session; and
prior to completion of the cell change, initiating a MBS session establishment procedure to cause the second cell to provide the MBS session.

9. The method of claim 8, wherein initiating the MBS session establishment procedure comprises transmitting a request to initiate the MBS session establishment procedure to the first cell or the second cell.

10. The method of claim 1, wherein the criterion associated with the first cell comprises at least one of:
a received signal level at the UE from the first cell;
a signal quality of MBS data associated with the MBS session; and
a reception quality of the MBS data associated with the MBS session.

11. The method of claim 10, wherein the received signal level comprises at least one of:
a reference signal received power, RSRP;
a reference signal received quality, RSRQ;
a cell selection received level value, S_{rxley}; and
a cell selection quality value, S_{qual},
wherein the signal quality of the MBS data comprises at least one of:
a signal to noise ratio, SNR; and
a signal to interference and noise ratio, SINR, and
wherein the reception quality of the MBS data comprises at least one of:
a bit error rate, BER; and
a block error rate, BLER.

12. The method of claim 1, further comprising:
measuring the criterion associated with the first cell and criterion associated with neighbouring cells while the communication device is in the low power state.

13. The method of claim 1, wherein the lower power state comprises a radio resource control, RRC, idle state or a RRC inactive state.

14. The method of claim 1, wherein attempting the cell change comprises failing to perform the cell change from the first cell to the second cell, the method further comprising:
responsive to failing to perform the cell change, reestablishing a connection with the first cell; and
responsive to reestablishing the connection with the first cell, stopping acquisition of MBS data from the MBS session from the first cell.

15. The method of claim 1, wherein attempting the cell change comprises failing to perform the cell change from the first cell to the second cell, the method further comprising:
responsive to failing to perform the cell change, reestablishing a connection with the first cell; and
responsive to reestablishing the connection with the first cell, resuming acquisition of MBS data from the MBS session from the first cell.

16. The method of claim 1, wherein attempting the cell change comprises failing to perform the cell change from the first cell to the second cell, the method further comprising:
responsive to failing to perform the cell change, performing a cell change to a fourth cell that provides the MBS session.

17. The method of claim 1, wherein determining that the first trigger for performing the cell change has occurred comprises:
determining that a criterion associated with a neighbour cell exceeds the criterion associated with the first cell by a threshold amount.

18. The method of claim 1, wherein determining that the first trigger for performing the cell change has occurred comprises:
receiving a message from the communications network instructing the communication device to perform the cell change.

19. A communication device operating in a communications network, the communication device comprising:
processing circuitry; and
memory coupled to the processing circuitry and having instructions stored therein that are executable by the processing circuitry to cause the communication device to;
receive a portion of multicast data of a multicast and broadcast services, MBS, session via a first cell of the communications network while the communication device is in a low power state;
determine that a first trigger for performing a cell change has occurred;
determine that a criterion associated with a second cell is better than a criterion associated with the first cell;
determine that a criterion associated with a third cell is better than the criterion associated with the second cell;
determine that the third cell is not providing the MBS session;
determine that the second cell is providing the MBS session; and
attempt, or not attempt, the cell change from the first cell to the second cell, taking into account one or both of whether MBS is supported by the second cell and whether an MBS session is already provided in the second cell.

20. A computer storage medium storing a computer program comprising program code executable by processing circuitry of a communication device operating in a communications network, execution of the program code causing the communication device to:
receive a portion of multicast data of a multicast and broadcast services, MBS, session via a first cell of the communications network while the communication device is in a low power state;
determine that a first trigger for performing a cell change has occurred;
determine that a criterion associated with a second cell is better than a criterion associated with the first cell;
determine that a criterion associated with a third cell is better than the criterion associated with the second cell;
determine that the third cell is not providing the MBS session;
determine that the second cell is providing the MBS session; and
attempt, or not emot, the cell change from the first cell to the second cell, taking into account one or both of whether MBS is supported by the second cell and whether an MBS ssion is already provided in the second cell.

21. (canceled)
